(19) United States
(12) Patent Application Publication
(10) Pub. No.: US 2018/0106198 A1
(43) Pub. Date: Apr. 19, 2018

(54) VARIABLE VALVE TRAIN FOR ENGINE

(71) Applicant: Mazda Motor Corporation, Aki-gun (JP)

(72) Inventors: Yoshiyuki Kamoyama, Hiroshima-shi (JP); Tsuyoshi Goto, Hiroshima-shi (JP)

(21) Appl. No.: 15/725,679

(22) Filed: Oct. 5, 2017

(30) Foreign Application Priority Data
Oct. 19, 2016 (JP) 2016-205329

(51) Int. Cl. F02D 13/02; F01L 1/344

(52) U.S. Cl. CPC F02D 13/0207; F01L 1/047; F01L 1/344

(57) ABSTRACT

A variable valve train for an engine is provided that includes a plurality of electric variable valve mechanisms, a single drive circuit used to drive at least two of the plurality of electric variable valve mechanisms, and a controller provided separately from the drive circuit and configured to control the drive circuit. The drive circuit is integrated with at least one of the at least two electric variable valve mechanisms.

### TECHNICAL FIELD

The present disclosure relates to a variable valve train for an engine, which includes a plurality of electric variable valve mechanisms.

### BACKGROUND OF THE DISCLOSURE

In some recent cases, engines for automobiles adopt electric variable valve mechanisms which are driven by a motor. Compared to hydraulic variable valve mechanisms, the electric variable valve mechanisms can exercise more precise control with good responsiveness. While hydraulic control with the hydraulic variable valve mechanism is not available at low temperatures or low engine speeds, the electric variable valve mechanism is advantageous in that it has a wider controllable temperature range and operating range.

When a plurality of variable valve mechanisms are provided, for example, the electric variable valve mechanism which has excellent controllability may be adopted for an intake system and the hydraulic variable valve mechanism, which costs less than the electric mechanism, may be adopted for an exhaust system. Alternatively, the electric variable valve mechanisms may be adopted for both the intake and exhaust systems.

For example, JP2008-267342A discloses a configuration in which a plurality of electric variable valve mechanisms are provided. In this configuration, a motor as a driving source is provided for each variable valve mechanism so that the variable valve mechanisms are individually operated. Further, as disclosed in FIG. 5 of JP2008-267342A for example, a drive circuit (driver) for controlling the motor based on a command from an engine controller (powertrain control module, PCM) is usually provided for each motor.

The drive circuit of each motor is structured by combining a plurality of electronic components so that a switch of the on/off state of the motor, switch of the normal/reverse rotation of the motor, rotational speed of the motor, rotational angle of the motor, etc. are controllable. The motor and the corresponding drive circuit are usually unitized by being accommodated in a single case, and disposed toward one end of a camshaft.

Incidentally, when the plurality of electric variable valve mechanisms are provided as described above, if the motor unit including the motor and the drive circuit is provided for each variable valve mechanism, the component cost increases.

In this regard, instead of unitizing the drive circuit with each motor, it may be considered to share a single drive circuit, which is provided independently from the motors, for controlling the plurality of motors. Thus, an overall reduction in component cost is achieved by reducing the number of drive circuits having a high unit price.

In this situation, however, additional components, such as a case for the drive circuit, a bracket for supporting the case, etc., are required in addition to the case for the motors, and space for the drive circuit to be disposed needs to be secured as well.

Further, in order to omit the case dedicated to the drive circuit and save space, it may also be considered to incorporate the drive circuit into a circuit board of an engine controller (PCM). In this case, heat generation by the drive circuit or a magnetic field generated by electric wires for supplying power from the drive circuit to the motors may cause a harmful effect on the engine controller. For example, the engine controller may experience heat damage; in a harness formed by bundling the electric wires for power supply together with other electric wires for communication, electromagnetic noise may be generated in the electric wires for communication; or a cost increase due to taking countermeasures for the electromagnetic noise may be caused.

### SUMMARY OF THE DISCLOSURE

Therefore, the present disclosure aims to reduce the overall cost of a variable valve train for an engine, which includes a plurality of electric variable valve mechanisms, while preventing an increase in the number of components used to accommodate a drive circuit of a motor, easily securing space for the drive circuit to be disposed, preventing heat damage due to heat generation by the drive circuit, and reducing electromagnetic noise due to the magnetic field generated by an electric wire for supplying power from the drive circuit to the motor.

According to one aspect of the present disclosure, a variable valve train for an engine is provided, which includes a plurality of electric variable valve mechanisms, a single drive circuit used to drive at least two of the plurality of electric variable valve mechanisms, and a controller provided separately from the drive circuit and configured to control the drive circuit. The drive circuit is integrated with at least one of the at least two electric variable valve mechanisms.

Here, “integrated with the electric variable valve mechanism” means that a component of the drive circuit is either integrated with a component of the electric variable valve mechanism, or supported by or accommodated inside the component of the electric variable valve mechanism.

According to this configuration, since a single drive circuit is shared for driving the plurality of electric variable valve mechanisms, the number of drive circuits is reduced, and thus, the overall component cost is reduced.

Further, since the drive circuit is integrated with at least one electric variable valve mechanism, a case dedicated to the drive circuit, a bracket for supporting the case, etc. are omitted, and no space dedicated to the disposition of the drive circuit is required.

In addition, since the drive circuit is provided separately from the controller that controls the drive circuit, even when a large current flows to the drive circuit or through electric wires which supply power from the drive circuit to a motor, etc., heat damage to the controller, and generation of electromagnetic noise in electric wires for communication in a harness connected to the controller, are prevented. Further, since the countermeasures for such electromagnetic noise are not required, the cost reduction is achieved.

The at least two electric variable valve mechanisms may include an intake variable valve mechanism that is used to open and close an intake valve, and an exhaust variable valve mechanism that is used to open and close an exhaust valve. The drive circuit may be integrated with the intake variable valve mechanism.

Here, “integrated with the intake variable valve mechanism” means that a component of the drive circuit is either integrated with a component of the intake variable valve mechanism, or supported by or accommodated inside the component of the intake variable valve mechanism.

According to this configuration, the intake variable valve mechanism with which the drive circuit is integrated is not easily increased in temperature compared to the exhaust variable valve mechanism which is exposed to high-temperature exhaust gas. Thus, heat damage of the drive circuit is effectively prevented.

Each of the at least two electric variable valve mechanisms may include a motor and a case accommodating the motor. The drive circuit may be accommodated inside the case of one of the at least two electric variable valve mechanisms.

According to this configuration, since the motor of one of the electric variable valve mechanisms and the drive circuit are accommodated inside the common case, the electric wire connecting the drive circuit with the motor is routed inside the case in a simple manner. Further, since the case is only required to accommodate one motor and one drive circuit, a unit including the motor, the drive circuit and the case is structured to be small.

Each of the at least two electric variable valve mechanisms may include a motor. The drive circuit may be accommodated inside a common case accommodating all the motors of the at least two electric variable valve mechanisms.

According to this configuration, since the motors of the plurality of electric variable valve mechanisms and the drive circuit are accommodated inside the common case, the electric wire connecting the drive circuit with each of the motor is routed inside the case in a simple manner. Further, since the drive circuit constitutes a single unit with all the motors, the number of units is reduced, and thus, the component cost and man-hours for assembly are reduced.

Each of the at least two electric variable valve mechanisms may change at least one of (a) opening and/or closing timings and (b) lift of a valve.

According to this configuration, the above described effects are obtained with the variable valve train for the engine including the plurality of electric variable valve mechanisms that are changeable of the opening and/or closing timings of the valve, the lift of the valve, or a combination thereof.

### BRIEF DESCRIPTION OF DRAWINGS

FIG. 1 is a top view of a variable valve train for an engine according to a first embodiment of the present disclosure.

FIG. 2 is a view illustrating a control system of a motor according to the first embodiment.

FIG. 3 is a view illustrating a control system of a motor according to a second embodiment.

### DETAILED DESCRIPTION OF THE DISCLOSURE

Hereinafter, a variable valve train for an engine according to the present disclosure is described for each embodiment, with reference to the accompanying drawings.

### First Embodiment

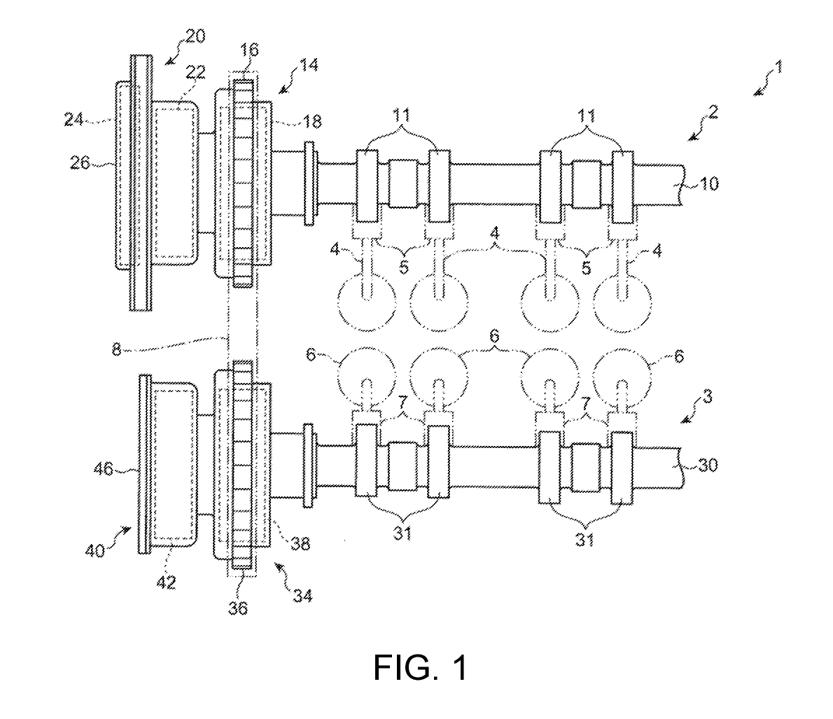

FIG. 1 is a top view of a variable valve train 1 for an engine according to a first embodiment. The variable valve train 1 is provided, for example, to an inline four-cylinder gasoline engine. Note that the type and specific structure of the engine are not particularly limited in the present disclosure.

The variable valve train 1 includes an intake variable valve mechanism 2 which opens and closes an intake valve 4 of the engine, and an exhaust variable valve mechanism 3 which opens and closes an exhaust valve 6 of the engine.

Note that FIG. 1 illustrates the intake and exhaust valves 4 and 6 for two cylinders by two-dotted chain line, and in the example of FIG. 1, two intake valves 4 and two exhaust valves 6 are provided for each cylinder.

The intake variable valve mechanism 2 is an electric variable valve timing mechanism (VVT) that changes opening and/or closing timings of the intake valves 4. The intake variable valve mechanism 2 includes an intake camshaft 10 extending in a direction in which the cylinders are lined up (cylinder line-up direction). The intake camshaft 10 is supported by a cylinder head (not illustrated).

The intake camshaft 10 is provided with a plurality of cams 11 spaced from each other in a longitudinal direction of the intake camshaft 10. The cam 11 is provided for each intake valve 4, and each cam 11 is engaged with the intake valve 4 via a rocker arm 5, for example.

The intake variable valve mechanism 2 also includes an intake-side driven unit 14 and an intake-side motor unit 20.

The intake-side driven unit 14 is provided at one end portion of the intake camshaft 10. An outer circumferential portion of the intake-side driven unit 14 is provided with a sprocket 16. The sprocket 16 is disposed coaxially to the intake camshaft 10. The sprocket 16 is wrapped around with a timing chain 8, and the sprocket 16 is drivably connected to a crankshaft (not illustrated) via the timing chain 8.

As the method of driving the intake camshaft 10, a belt or gear driving method may be adopted instead of driving with the timing chain.

The intake-side driven unit 14 includes a phase shifting mechanism 18 which changes the phase of the intake camshaft 10. The phase shifting mechanism 18 may adopt any well-known mechanism. The sprocket 16 is connected to the intake camshaft 10 via the phase shifting mechanism 18. Thus, rotation inputted to the sprocket 16 from the crankshaft side is phase shifted or maintained by the phase shifting mechanism 18 and then transmitted to the intake camshaft 10.

The intake-side motor unit 20 is drivably connected to the end portion of the intake camshaft 10 via the intake-side driven unit 14, and is attached to a front cover (not illustrated). The intake-side motor unit 20 includes an intake-side motor 22 which operates the phase shifting mechanism 18, a drive circuit 24 disposed adjacent to the intake-side motor 22 on the opposite side from the intake camshaft 10, and a case 26 accommodating the intake-side motor 22 and the drive circuit 24.

An output shaft of the intake-side motor 22 is drivably connected to the intake camshaft 10 via the phase shifting mechanism 18 so as to rotate together with the intake camshaft 10. When the output rotational speed of the intake-side motor 22 is at a given rotational speed that is synchronized with the rotational speed of the intake camshaft 10, the phase of the intake camshaft 10 is maintained. When the output rotational speed of the intake-side motor 22 exceeds the given rotational speed, the phase of the intake camshaft 10 is advanced, and when the output rotational speed of the intake-side motor 22 falls below the given rotational speed, the phase of the intake camshaft 10 is retarded.

On the contrary, the phase of the intake camshaft 10 may be retarded when the output rotational speed of the intake-side motor 22 exceeds the given rotational speed, and the phase of the intake camshaft 10 may be advanced when the output rotational speed of the intake-side motor 22 falls below the given rotational speed.

The exhaust variable valve mechanism 3 is an electric variable valve timing mechanism (VVT) that changes opening and/or closing timings of the exhaust valve 6. The exhaust variable valve mechanism 3 includes an exhaust camshaft 30 extending in the cylinder line-up direction. The exhaust camshaft 30 is supported by the cylinder head.

The exhaust camshaft 30 is provided with a plurality of cams 31 spaced from each other in a longitudinal direction of the exhaust camshaft 30. The cam 31 is provided for each exhaust valve 6, and each cam 31 is engaged with the exhaust valve 6 via a rocker arm 7, for example.

The exhaust variable valve mechanism 3 also includes an exhaust-side driven unit 34 and an exhaust-side motor unit 40.

The exhaust-side driven unit 34 is provided at one end portion of the exhaust camshaft 30. The exhaust-side driven unit 34 is disposed at the same position as the intake-side driven unit 14 in the cylinder line-up direction. The exhaust-side driven unit 34 is disposed adjacent to the intake-side driven unit 14 in an orthogonal direction to the cylinder line-up direction.

An outer circumferential portion of the exhaust-side driven unit 34 is provided with a sprocket 36. The sprocket 36 is disposed coaxially to the exhaust camshaft 30. The sprocket 36 is wrapped around with the timing chain 8, and the sprocket 36 is drivably connected to the crankshaft via the timing chain 8.

Note that, as the method of driving the exhaust camshaft 30, a belt or gear driving method may be adopted instead of driving with the timing chain, similarly to that in the intake system.

The exhaust-side driven unit 34 includes a phase shifting mechanism 38 which changes the phase of the exhaust camshaft 30. The phase shifting mechanism 38 may adopt any well-known mechanism. The sprocket 36 is connected to the exhaust camshaft 30 via the phase shifting mechanism 38. Thus, rotation inputted to the sprocket 36 from the crankshaft side is phase shifted or maintained by the phase shifting mechanism 38 and then transmitted to the exhaust camshaft 30.

The exhaust-side motor unit 40 is drivably connected to the end portion of the exhaust camshaft 30 via the exhaust-side driven unit 34, and is attached to the front cover. The exhaust-side motor unit 40 includes an exhaust-side motor 42 which operates the phase shifting mechanism 38, and a case 46 accommodating the exhaust-side motor 42.

An output shaft of the exhaust-side motor 42 is drivably connected to the exhaust camshaft 30 via the phase shifting mechanism 38 so as to rotate together with the exhaust camshaft 30. When the output rotational speed of the exhaust-side motor 42 is at a given rotational speed that is synchronized with the rotational speed of the exhaust camshaft 30, the phase of the exhaust camshaft 30 is maintained. When the output rotational speed of the exhaust-side motor 42 exceeds the given rotational speed, the phase of the exhaust camshaft 30 is advanced, and when the output rotational speed of the exhaust-side motor 42 falls below the given rotational speed, the phase of the exhaust camshaft 30 is retarded.

On the contrary, the phase of the exhaust camshaft 30 may be retarded when the output rotational speed of the exhaust-side motor 42 exceeds the given rotational speed, and the phase of the exhaust camshaft 30 may be advanced when the output rotational speed of the exhaust-side motor 42 falls below the given rotational speed.

The exhaust-side motor 42 is disposed at the same position as the intake-side motor 22 in the cylinder line-up direction. The exhaust-side motor 42 is disposed adjacent to the intake-side motor 22 in an orthogonal direction to the cylinder line-up direction. The case 46 of the exhaust-side motor unit 40 is structured to be smaller than the case 26 of the intake-side motor unit 20 in the cylinder line-up direction.

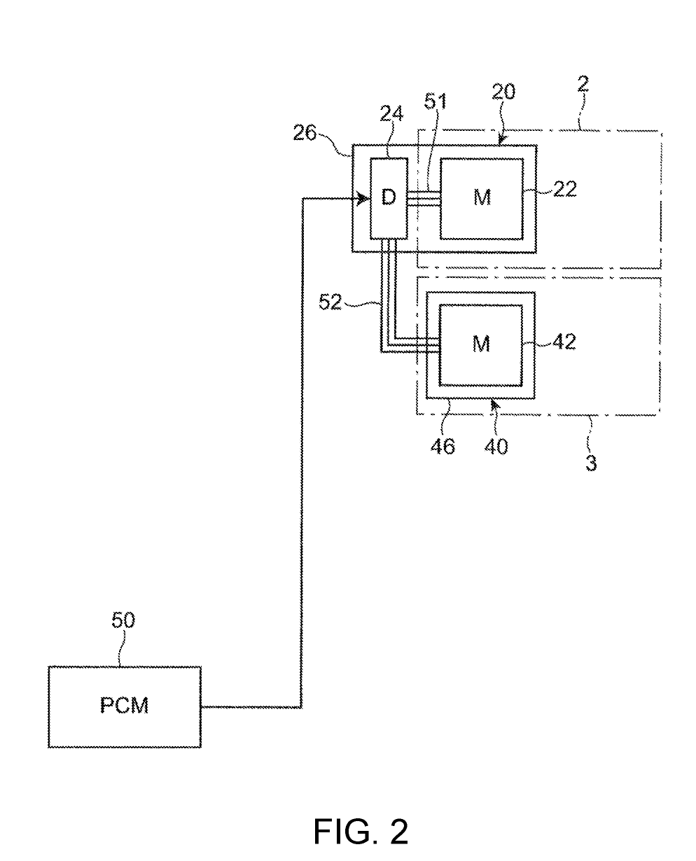

As illustrated in FIG. 2, the drive circuit 24 is drivably connected to both the intake-side motor 22 and the exhaust-side motor 42 via electric wires 51 and 52 for power supply (hereinafter, each wire for power supply may simply be referred to as “power wire”). Thus, the drive circuit 24 is used for driving the intake variable valve mechanism 2 and the exhaust variable valve mechanism 3.

The electric wire 51 connecting the drive circuit 24 to the intake-side motor 22 is entirely accommodated inside the case 26 of the intake-side motor unit 20. The electric wire 52 connecting the drive circuit 24 to the exhaust-side motor 42 is routed outside of the cases 26 and 46 of the intake-side motor unit 20 and the exhaust-side motor unit 40.

A control signal transmitted from a PCM (powertrain control module) 50 (engine controller) is inputted to the drive circuit 24 and thus is controlled by the PCM 50. The PCM 50 controls various operations of the engine and is configured, for example, by having a microprocessor as a main part. The PCM 50 is provided separately from the drive circuit 24 and is provided at an arbitrary location in the vehicle, away from the engine.

According to the first embodiment, since a single drive circuit 24 is shared for driving the two intake and exhaust variable valve mechanisms 2 and 3, the number of expensive drive circuits is reduced compared to when the drive circuit is provided for the variable valve mechanisms 2 and 3 individually, and thus, the overall component cost is reduced.

In the first embodiment, the drive circuit 24 is integrated with the intake variable valve mechanism 2 by being accommodated inside the case 26 of the intake-side motor unit 20. Therefore, unlike when a separate drive circuit is provided at a different location from the intake variable valve mechanism 2 and the exhaust variable valve mechanism 3, a case dedicated to the drive circuit, a bracket for supporting the case, etc. are omitted, and no space dedicated to the disposition of the drive circuit is required.

In the first embodiment, the intake variable valve mechanism 2 that is integrated with the drive circuit 24 is more difficult to be increased in temperature compared to the exhaust variable valve mechanism 3 which is exposed to high-temperature exhaust gas. Thus, heat damage to the drive circuit 24 is effectively prevented.

Further according to the first embodiment, the intake-side motor 22 and the drive circuit 24 are accommodated inside a common case 26 and adjacently disposed therein. Therefore, the electric wire 51 connecting the drive circuit 24 with the intake-side motor 22 is routed for a short distance and in a simple manner.

Since the case 26 of the intake-side motor unit 20 is only required to accommodate one intake-side motor 22 and one drive circuit 24, the intake-side motor unit 20 is structured to be small as a whole.

Since the intake-side motor 22 and the exhaust-side motor 42 are adjacently disposed, the electric wire 52 connecting the drive circuit 24, which is provided to the intake-side motor unit 20, with the exhaust-side motor 42 is routed for a short distance and in a simple manner.

Since the case 46 of the exhaust-side motor unit 40 does not accommodate the drive circuit 24 and only accommodates a single exhaust-side motor 42, the exhaust-side motor unit 40 is effectively reduced in size.

The power wire 51, which is routed for a short distance and in a simple manner inside the case 26 of the intake-side motor unit 20, does not form a harness by being bundled with other electric wires. Further, between the intake-side motor unit 20 and the exhaust-side motor unit 40, there is no need for some communications or power supply to anything other than the exhaust-side motor 42. Therefore, the power wire 52, which is routed for a short distance and in a simple manner from the drive circuit 24 of the intake-side motor unit 20 to the exhaust-side motor 42 of the exhaust-side motor unit 40, also does not form a harness by being bundled with other electric wires.

Therefore, during operation of the intake-side motor 22 and the exhaust-side motor 42, even when a large current flows through the electric wires 51 and 52, generation of electromagnetic noise in an electric wire for communication is prevented. Further, since the countermeasures for such electromagnetic noise are not required, the cost reduction is achieved.

In the first embodiment, the drive circuit 24 is provided separately from the PCM 50 and disposed away from the PCM 50. Therefore, during operation of the intake-side motor 22 and the exhaust-side motor 42, even when a large current flows to the drive circuit 24, heat damage to the PCM 50 is prevented.

### Second Embodiment

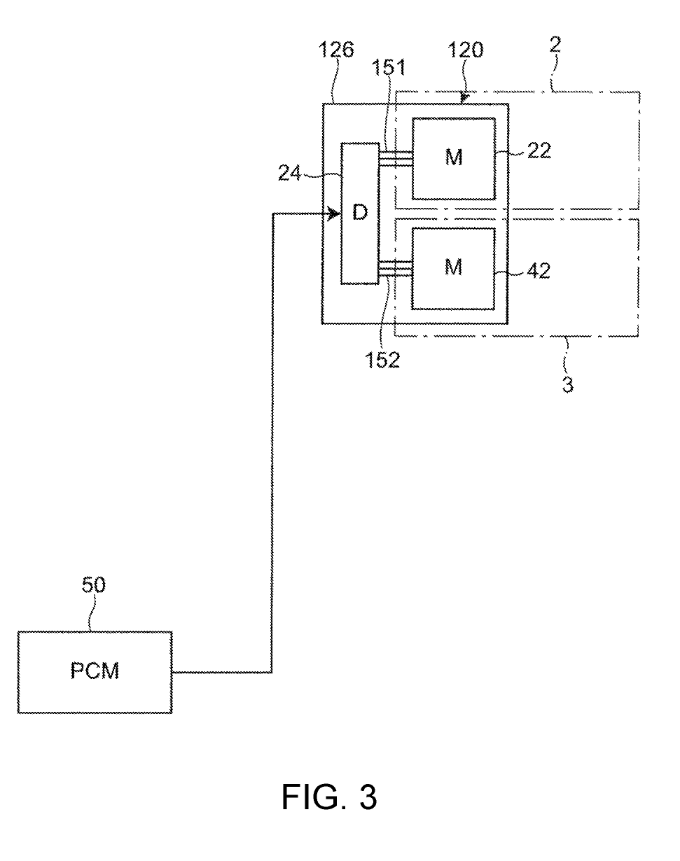

With reference to FIG. 3, a variable valve train for an engine according to a second embodiment is described. Note that the components similar to those in the first embodiment are assigned with the same reference characters in FIG. 3, and description thereof is omitted. As illustrated in FIG. 3, in the second embodiment, the drive circuit 24 is connected to the intake- and exhaust-side motors 22 and 42 via power wires 151 and 152, respectively, and is controlled by the PCM 50, which is similar to the first embodiment.

On the other hand, in the second embodiment, the intake- and exhaust-side motors 22 and 42 are accommodated inside a common case 126, which is different from the first embodiment. Thus, the intake- and exhaust-side motors 22 and 42 constitute a common motor unit 120.

The case 126 of the motor unit 120 also accommodates the drive circuit 24. Further, the electric wire 151 connecting the drive circuit 24 to the intake-side motor 22, and the electric wire 152 connecting the drive circuit 24 to the exhaust-side motor 42 are also accommodated inside the common case 126 as a whole.

According to the second embodiment, by accommodating all the intake-side motor 22, the exhaust-side motor 42, and the drive circuit 24 inside the common case 126, the electric wires 151 and 152 connecting between the drive circuit 24 and each of the motors 22 and 42 are routed for a short distance and in a simple manner.

Since the drive circuit 24 constitutes a single motor unit 120 together with the intake- and exhaust-side motors 22 and 42, compared to when the motor unit is structured for each of the motors 22 and 42, the component cost and man-hour for assembling are reduced.

Further, similar to the first embodiment, since the single drive circuit 24 drives the two variable valve mechanisms 2 and 3, the number of expensive drive circuits is reduced, which leads to an overall reduction in component cost.

Further, the drive circuit 24 is integrated with the intake and exhaust variable valve mechanisms 2 and 3 by being accommodated inside the case 126 of the motor unit 120. Therefore, unlike when a separate drive circuit is provided at a different location from the intake and exhaust variable valve mechanisms 2 and 3, a case dedicated to the drive circuit, a bracket for supporting the case, etc. are omitted, and no arranging space dedicated to the drive circuit is required.

The power wires 151 and 152, which are routed for a short distance and in a simple manner inside the case 126, do not form a harness by being bundled with other electric wires. Therefore, during operation of the intake-side motor 22 and the exhaust-side motor 42, even when a large current flows through the electric wires 151 and 152, generation of electromagnetic noise in an electric wire for communication is prevented. Further, since the countermeasures for such electromagnetic noise are not required, the cost reduction is achieved.

Moreover, similar to the first embodiment, the drive circuit 24 is provided separately from the PCM 50 and disposed away from the PCM 50. Therefore, during operation of the intake-side motor 22 and the exhaust-side motor 42, even when a large current flows to the drive circuit 24, heat damage to the PCM 50 is prevented.

Although the present disclosure is described with the embodiments as described above, it is not limited to these embodiments.

For example, in the above embodiments, the variable valve train for the engine, which includes the single intake variable valve mechanism and the single exhaust variable valve mechanism as the plurality of electric variable valve mechanisms, is described. However, in the present disclosure, the plurality of electric variable valve mechanisms may only include one of the intake-side mechanism and the exhaust-side mechanism. The variable valve train for the engine according to the present disclosure may include three or more electric variable valve mechanisms.

Further in the above embodiments, the example in which the single drive circuit is used for driving the two electric variable valve mechanisms is described. However, in the present disclosure, the single drive circuit may be used for driving three or more electric variable valve mechanisms.

Moreover in the above embodiments, the example in which the drive circuit is integrated with at least one of the electric variable valve mechanisms by being accommodated inside the case of the motor unit is described. However, in the present disclosure, the integrated structure of the drive circuit with the at least one of the electric variable valve mechanisms is not limited to this, and for example, the drive circuit may be integrated with the bracket which supports the motors, or the motors and the drive circuit may be supported by a common bracket.

Furthermore, in the above embodiments, the example in which the electric variable valve mechanisms which are driven by the drive circuit are the variable valve timing mechanism (VVT) which changes the opening and/or closing timings of the valve is described. However, in the present disclosure, the electric variable valve mechanism which is driven by the drive circuit may change the lift of the valve or change all the opening and/or closing timings and the lift.

As described above, according to the present disclosure, in the variable valve train for the engine including the plurality of electric variable valve mechanisms, it is possible to reduce the overall cost while preventing an increase in the number of components used to accommodate a drive circuit of a motor, easily securing space for the drive circuit to be disposed, preventing heat damage due to heat generation by the drive circuit, and reducing electromagnetic noise due to the magnetic field generated by an electric wire for power supply from the drive circuit to the motor. Therefore, it is possible that the present disclosure is suitably applied in the industrial fields of manufacturing automobile engines which adopt an electric variable valve mechanism.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### DESCRIPTION OF REFERENCE CHARACTERS

1 Variable Valve Train for Engine

2 Intake Variable Valve Mechanism

3 Exhaust Variable Valve Mechanism

4 Intake Valve

6 Exhaust Valve

8 Timing Chain

10 Intake Camshaft

11 Cam

14 Intake-side Driven Unit

16 Sprocket

18 Phase Shifting Mechanism

20 Intake-side Motor Unit

22 Intake-side Motor

24 Drive Circuit

26 Case

30 Exhaust Camshaft

31 Cam

34 Exhaust-side Driven Unit

36 Sprocket

38 Phase Shifting Mechanism

40 Exhaust-side Motor Unit

42 Exhaust-side Motor

46 Case

50 PCM (Engine Controller)

51, 52 Electric Wire for Power Supply

120 Motor Unit

126 Case

151, 152 Electric Wire for Power Supply

What is claimed is:

1. A variable valve train for an engine, comprising:
a plurality of electric variable valve mechanisms;
a single drive circuit used to drive at least two of the plurality of electric variable valve mechanisms; and
a controller provided separately from the drive circuit and configured to control the drive circuit,
wherein the drive circuit is integrated with at least one of the at least two electric variable valve mechanisms.

2. The valve train of claim 1, wherein
the at least two electric variable valve mechanisms include an intake variable valve mechanism that is used to open and close an intake valve, and an exhaust variable valve mechanism that is used to open and close an exhaust valve, and
the drive circuit is integrated with the intake variable valve mechanism.

3. The valve train of claim 1, wherein
each of the at least two electric variable valve mechanisms includes a motor and a case accommodating the motor, and
the drive circuit is accommodated inside the case of one of the at least two electric variable valve mechanisms.

4. The valve train of claim 1, wherein
each of the at least two electric variable valve mechanisms includes a motor, and
the drive circuit is accommodated inside a common case accommodating all the motors of the at least two electric variable valve mechanisms.

5. The valve train of claim 1, wherein each of the at least two electric variable valve mechanisms changes at least one of (a) opening and/or closing timings and (b) lift of a valve.
